(19) United States
(12) Patent Application Publication
(10) Pub. No.: US 2020/0231371 A1
(43) Pub. Date: Jul. 23, 2020

(54) ADAPTER FOR USE IN A PORTION CAPSULE MACHINE AND SYSTEM

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 16/500,853

(22) PCT Filed: Apr. 6, 2018
(86) PCT No.: PCT/EP2018/058915

§ 371 Date: Oct. 4, 2019

(30) Foreign Application Priority Data
Apr. 7, 2017 (DE) 10 2017 206 048.4

(51) Int. Cl. B65D 85/804; A47J 31/44

(52) U.S. Cl. CPC B65D 85/8043; A47J 31/3628; A47J 31/4492

(57) ABSTRACT

The invention relates to an adapter (1) for use in a portion capsule machine, the adapter (1) having an adapter main body (2), which has a receptacle (3), the receptacle (3) being provided for receiving a portion capsule (4), the adapter main body (2) also having a peripherally extending flange (5), which is provided with an identifying means (6) at least in some regions, or the adapter main body (2) being designed as a ring, in the center of which the receptacle for the portion capsule (4) is formed. The invention further relates to a corresponding system of an adapter and of a portion capsule and optionally of a portion capsule machine.

### PRIOR ART

The present invention relates to an adapter for use in a single-serve capsule machine, the adapter having an adapter main body with a receptacle, the receptacle being provided to receive a single-serve capsule.

Single-serve capsules, which are used to produce beverages, in particular coffee or tea beverages, often have very different shapes and/or sizes. To be able nevertheless to use different single-serve capsules in different machines, adapters are known to a person skilled in the art, for example from US 2015/0056331 A1, WO 2014/163497 A1 or WO 2014/128542 A1, which adapters allow different single-serve capsules to be rendered compatible with different coffee machines.

### DISCLOSURE OF THE INVENTION

The object of the present invention was to make available an improved adapter, which in particular also affords the possibility of using a conventional single-serve capsule in a single-serve capsule machine of the kind which starts only when a corresponding identification means on the single-serve capsule has been able to be read out and/or which is based on a rotation of the brewing chamber.

The object is achieved by an adapter for use in a single-serve capsule machine, the adapter having an adapter main body with a receptacle, the receptacle being provided to receive a single-serve capsule, characterized in that the adapter main body also has a peripheral flange, which is provided with an identification means at least in some regions.

The identification means is thus preferably not arranged on the single-serve capsule but instead on the adapter for receiving the single-serve capsule. This has the advantageous result that, with the aid of the adapter according to the invention having the identification means to be read out, conventional single-serve capsules can also be used in single-serve capsule machines of the kind which start the beverage production process only when a corresponding identification means has been able to be read out from the single-serve capsule.

The adapter is either an adapter to be disposed of after a single use or a reusable adapter that is equipped successively with several different single-serve capsules.

The identification means preferably comprises a barcode and/or a two-dimensional barcode, which is formed in particular peripherally, particularly preferably on an upper face or on a lower face of the flange of the adapter.

The adapter, in the region of the receptacle, preferably has a latching means for form-fit and force-fit latching onto the single-serve capsule.

A further preferred embodiment of the present invention, or a further subject of the present invention for solving the problem mentioned at the outset, is an adapter for use in a single-serve capsule machine, the adapter having an adapter main body with a receptacle, the receptacle being provided to receive a single-serve capsule, wherein the adapter main body is configured as a ring, in the center of which the receptacle for the single-serve capsule is fonaed.

By virtue of its annular shape, the adapter according to the invention advantageously permits the use of conventional single-serve capsules in single-serve capsule machines of the kind that are based on a rotation of the brewing chamber.

Preferably, the adapter according to the invention moreover has the peripheral flange, which is provided with the identification means at least in some regions. The identification means here is preferably also a barcode and/or a two-dimensional barcode which is formed preferably peripherally, in particular on the upper face or on the lower face of the flange.

It is conceivable that the adapter, in the region of the receptacle, comprises a latching means for form-fit and force-fit latching onto the single-serve capsule, such that unwanted separation of single-serve capsule and adapter is prevented, particularly during the insertion of the adapter, equipped with a single-serve capsule, into the single-serve capsule machine.

According to a preferred embodiment of the present invention, provision is made that the ring is in two parts, wherein a first ring segment of the ring is reversibly connectable to a second ring segment, wherein preferably the first and the second ring segment are each configured in the form of a semicircle. In the peripheral direction of the ring, the ring thus consists of the two ring segments. The adapter is preferably configured in such a way that, by connecting the first ring segment to the second ring segment, the ring is generated and the single-serve capsule is fixed in the receptacle, wherein in particular the single-serve capsule is clamped between the first ring segment and the second ring segment. The first ring segment, and the second ring segment can in particular be latched onto each other in order to form the ring. Advantageously, the adapter can thus be clipped together in particular around the single-serve capsule, as a result of which the single-serve capsule is then fixed inside the ring.

According to a preferred alternative embodiment of the present invention, provision is made that the ring is in one part.

It is also conceivable that the adapter has a further ring, wherein the ring and the further ring are reversibly connectable to each other and are in particular iatchable onto each other. The two rings are in particular arranged one above the other during the connection and latched onto each other. It is conceivable that, in the connected state, one ring is arranged under a flange of the single-serve capsule, and the other ring is arranged above the flange of the single-serve capsule, such that the single-serve capsule is also fixed in the adapter here by connection of the two rings. In other words, the adapter is preferably configured in such a way that connecting the ring to the further ring fixes the single-serve capsule in the receptacle, wherein in particular a flange of the single-serve capsule is fastened with form-fit engagement, preferably clamped, between the ring and the further ring.

According to a preferred embodiment of the present invention, provision is made that the receptacle comprises a peripheral depression in the adapter main body, in which depression a flange of the single-serve capsule can be received flush therewith.

According to a preferred embodiment of the present invention, provision is made that the receptacle comprises a peripheral edge in the adapter main body, in which peripheral edge lies a stacking edge formed in the outer contour of the single-serve capsule.

According to a preferred embodiment of the present invention, provision is made that an outer contour of the adapter is at least partially convex. The outer contour in particular forms a spherical bulge (also referred to as a “dome”). In this way, a for example polygonal and cylindrical outer shape of the single-serve capsule can be adapted to a concave and spherically bulged shape of a brewing chamber.

According to a preferred embodiment of the present invention, provision is made that the adapter is designed to hold the single-serve capsule in a rotating brewing chamber of the single-serve capsule machine. It is conceivable that an anti-twist means for receiving the single-serve capsule in a manner fixed in rotation is provided between adapter and single-serve capsule, such that a rotation of the single-serve capsule with respect to the adapter in the rotating brewing chamber is suppressed. The anti-twist means can be realised by clamping the single-serve capsule and/or the flange of the single-serve capsule with force-fit engagement in the receptacle or in the adapter main body. Alternatively, it is also conceivable that sharp puncturing tips, issuing from the adapter, easily pierce into the wall and/or the flange of the single-serve capsule, in particular during the connection of first ring segment and second ring segment or of ring and further ring, thereby holding the single-serve capsule in position relative to the adapter when the adapter rotates in the brewing chamber.

According to a preferred embodiment of the present invention, provision is made that the lengthwise extent of the adapter along its longitudinal axis is shorter than the lengthwise extent of the single-serve capsule along the longitudinal axis.

A further subject matter of the present invention is a system consisting of the adapter according to the invention and of the single-serve capsule.

The single-serve capsule preferably has a capsule body in which the beverage raw material, optionally a filter and optionally a liquid distributor, is provided. The capsule body has a wall and a bottom. The wall is preferably provided in a conical manner and, at one end thereof, has a bottom which is provided in one piece with the wall. A radius of curvature is provided in the transition region between the wall. The wall preferably has a plurality of ribs which run in particular parallel to the bottom, extend over the entire circumference of the wall, and are provided equidistantly with respect to one another. The ribs have a greater diameter than the wall itself, wherein a rib, in particular the rib, which is closest to the bottom has a greater diameter than the other ribs. Furthermore, the wall preferably has a projection in the region of the end which lies opposite the bottom, which projection serves firstly as a stacking edge and secondly as a support for the circumferential edge in the adapter. Furthermore, a collar is preferably provided at that end of the wall which lies opposite the bottom, which collar extends parallel to the bottom and to which collar a cover film that closes the capsule body is fastened, in particular sealed. The bottom preferably has a circularly annular embossing, and the bottom very particularly preferably bulges inward within said embossing. The filter is preferably fastened, in particular sealed, to the bottom, the sealing seam being provided in particular in a circularly annular manner, wherein the sealing seam and the circularly annular embossing preferably have the same diameter. However, the internal diatneter and external diameter can in each case differ. The beverage raw material comprises in particular instant coffee powder and/or roasted and ground coffee beans, tea, cocoa, dried milk powder or the like.

According to a preferred embodiment of the present invention, provision is made that the system moreover comprises a single-serve capsule machine. The single-serve capsule machine preferably has a brewing chamber for receiving the adapter equipped with a single-serve capsule, wherein the single-serve capsule machine has at least one perforating means for generating at least one inlet opening in a cover film of the single-serve capsule, through which opening brewing liquid is conveyed into the single-serve capsule, and wherein the single-serve capsule machine has at least one perforating means for generating at least one outlet opening in the cover film, through which opening a beverage generated inside the single-serve capsule, by interaction of the brewing liquid with a beverage substrate, is conveyed out of the single-serve capsule.

According to a preferred embodiment of the present invention, provision is made that the brewing chamber can be driven at least partly in rotation during the extraction process, as a result of which a flow of the beverage through the at least one outlet opening is assisted. The outlet opening preferably lies to the outside of the inlet opening, in a radial direction with respect to the axis of rotation of the brewing chamber, such that the beverage, assisted by the centrifugal forces, is moved in the direction of the outlet opening.

Further details, features and advantages of the invention will become clear from the drawings, and also from the following description of preferred embodiments on the basis of the drawings. The drawings merely illustrate embodiments of the invention that are given by way of example and do not restrict the essential concept of the invention.

### BRIEF DESCRIPTION OF THE DRAWINGS

FIGS. 1a and 1b show a schematic sectional view and a schematic plan view of an adapter and of a system in a first illustrative embodiment of the present invention.

FIGS. 2a and 2b show a schematic sectional view and a schematic plan view of an adapter and of a system in a second illustrative embodiment of the present invention.

FIGS. 3a and 3b show a schematic sectional view and a schematic plan view of an adapter and of a system in a third illustrative embodiment of the present invention.

FIG. 4 shows a view of the peripheral flange of the adapter in the first, second and third embodiments of the present invention.

### EMBODIMENTS OF THE INVENTION

In the various figures, identical parts are always provided with the same reference signs and are therefore also as a rule named or mentioned in each case only once.

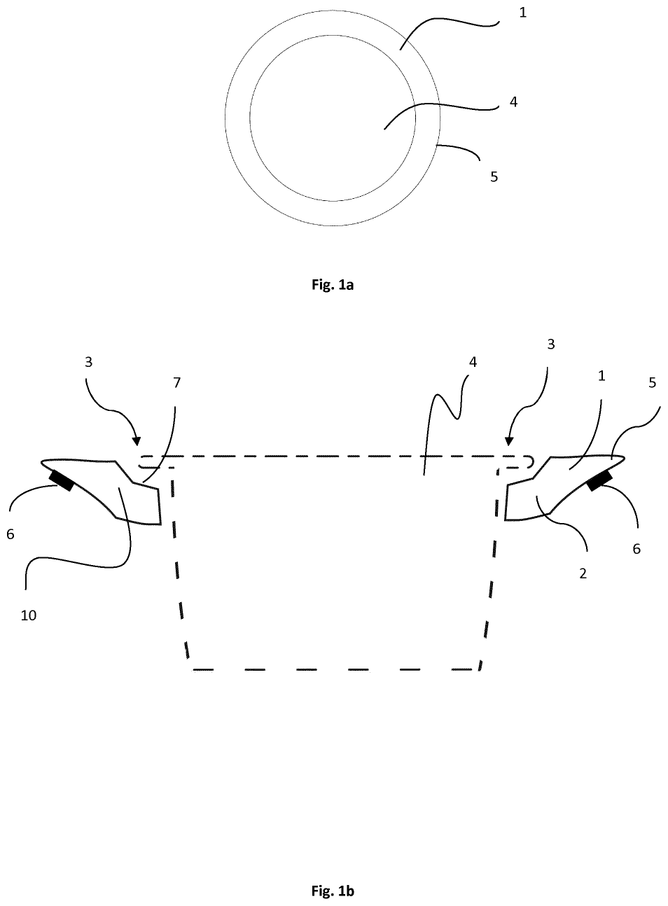

FIGS. 1a and 1b show a schematic sectional view and a schematic plan view of an adapter 1 and of a system in a first illustrative embodiment of the present invention.

The adapter 1 is intended to be equipped with a single-serve capsule 4 and then to be inserted, as a system together with the single-serve capsule 4, into the brewing chamber of a single-serve capsule machine. Through the use of the adapter 1, a conventional single-serve capsule 4 can then be used in a single-serve capsule machine of the kind which starts only when a corresponding identification means on the single-serve capsule 4 has been able to be read out and which is based on a rotation of the brewing chamber. Moreover, the outer contour of the single-serve capsule 4 can be adapted to the inner contour of the brewing chamber.

The adapter 1 for this purpose has an adapter main body 2 with a receptacle 3. The receptacle 3 is provided to receive the single-serve capsule 4. The adapter main body 2 is configured in the form of a ring 10, in the center of which the single-serve capsule 4 is arranged. The ring 10 is in particular in one part.

In the region of the receptacle 3, the adapter main body 2 has a peripheral depression 7 in the form of a step in the adapter main body 2, which depression is provided to receive the flange of the single-serve capsule 4 with a flush fit.

Moreover, in the region of the receptacle 3, and in particular in the region of the depression 5, the adapter 1 has a latching means for form-fit and force-fit latching onto the single-serve capsule 4. Alternatively, the opening within the ring is dimensioned in such a way that the single-serve capsule 5 is clamped there, for example by frictional engagement.

The outer contour of the adapter 1 is partially convex, in particular in the form of a spherical bulge (also referred to as a “dome”), such that the adapter 1 can be inserted into a concave and spherically bulged brewing chamber. In addition, it will be seen from FIG. 1b that the height of the single-serve capsule 4 is greater than the height of the adapter 1.

A peripheral flange 5 is also formed on the adapter main body 2. On the lower face, the flange 5 is provided with an identification means 6 in the form of a barcode. The barcode extends peripherally along the flange 5 and serves to ensure that the single-serve capsule machine recognizes the adapter 1 as a system-compatible capsule and initiates the extraction process, such that, with the aid of the adapter 1, the single-serve capsule 4 located in the adapter 1 is used to produce the desired beverage.

To produce the beverage, the single-serve capsule 4 is placed into the adapter, and the adapter 1 is then inserted with the single-serve capsule 4 into the brewing chamber of the single-serve capsule machine, which is in particular a part of the system. The barcode is then read out by a detection device of the single-serve capsule machine and recognized and, as a result of this, the beverage production process is started. For this purpose, a cover film of the single-serve capsule 4 is perforated by a perforating means of the single-serve capsule machine in order to form an inlet opening in the cover film, through which opening hot water can be introduced at pressure into the single-serve capsule 4 in order to produce the beverage. Moreover, the cover film is perforated by further perforating means of the single-serve capsule machine in order to form several outlet openings in the cover film, through which openings the beverage produced in the single-serve capsule 4 is conveyed out of the single-serve capsule 4. Moreover, during the process of production of the beverage, the brewing chamber is driven in rotation about its own axis. The outlet openings lie farther to the outside than the inlet opening, in a radial direction starting from the axis of rotation, wherein the inlet opening is preferably formed substantially at the center of the cover film, and the outlet openings are formed at the edge (adjacent to the flange) of the single-serve capsule 4. As a result of the centrifugal forces acting on the beverage liquid during the rotation of the single-serve capsule 4, the beverage produced in the single-serve capsule is driven out of the outlet openings.

The single-serve capsule 4 is fastened inside the adapter 1 in particular in such a way that an anti-twist means is formed, by which a rotation of the single-serve capsule 4 relative to the adapter 1 is suppressed.

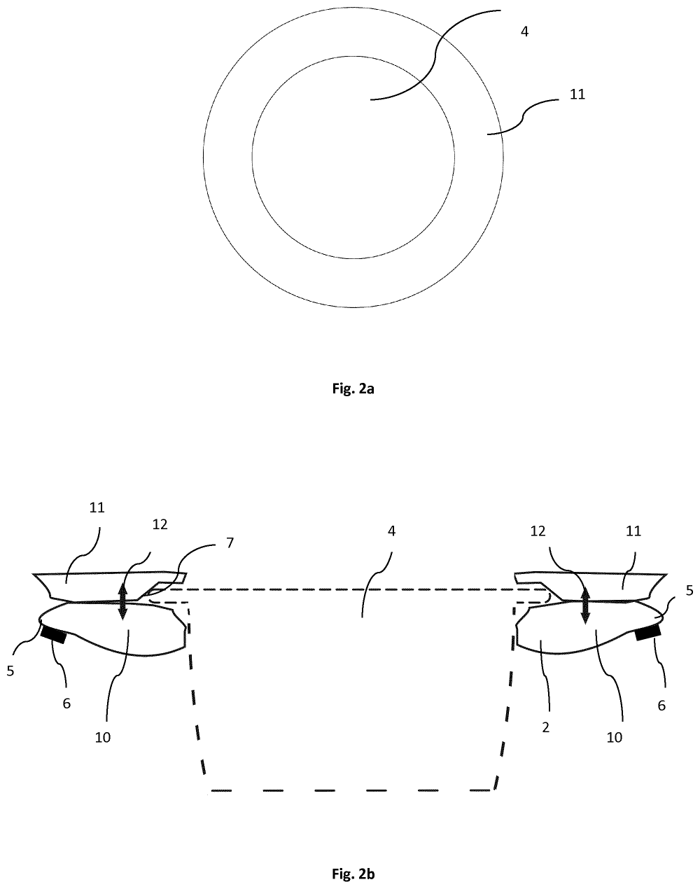

FIGS. 2a and 2b show a schematic sectional view and a schematic, plan view of an adapter 1 and of a system in a second illustrative embodiment of the present invention. The second embodiment corresponds substantially to the first embodiment explained with reference to FIGS. 1a and 1b, the sole difference being that the adapter 1 has a further ring 10.

The further ring 11 is mounted on the ring 10 (as is illustrated by the arrows 12) as soon as the single-serve capsule 4 has been inserted into the ring 10. The further ring 11 is connected to the ring 10 via a latch connection or a magnetic connection or a reversible bended connection.

The further ring 11 overlaps the flange of the single-serve capsule 4, such that the flange of the single-serve capsule is received with form-fit engagement between the ring 10 and the further ring 11 and is in particular clamped between them with force-fit engagement.

In this embodiment, the depression 7 is formed by way of example on the further ring 11 instead of on the ring 10. Formation of the depression 7 on the ring 10 or on both rings 10, 11 would also be conceivable.

The single-serve capsule 4 is fastened inside the adapter 1 in particular in .such a way that an anti-twist means is formed, by which a rotation of the single-serve capsule 4 relative to the adapter 1 is suppressed.

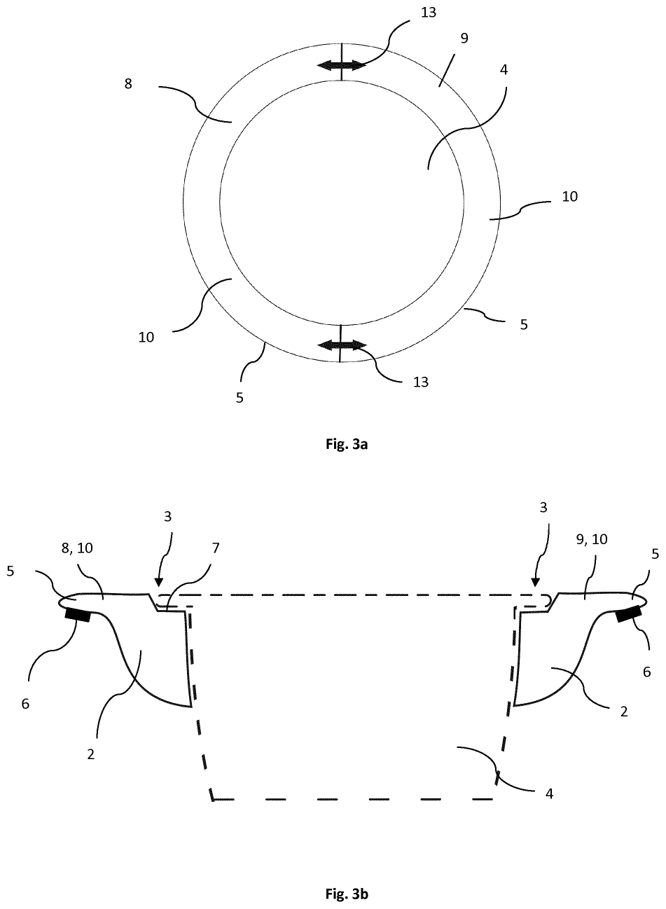

FIGS. 3a and 3b show a schematic sectional view and a schematic plan view of an adapter 1 and of a system in a third illustrative embodiment, of the present invention. The third embodiment corresponds substantially to the first embodiment explained with reference to FIGS. 1a and 1b, the sole difference being that the ring 10 is no longer formed in one part, but instead in two parts.

The ring 10 for this purpose comprises a first ring segment 6 and a second ring segment 9, which are each of semicircular shape. To equip the adapter 1 with a single-serve capsule 4, the two ring segments 8, 9 are positioned around the single-serve capsule 1 and then connected to each other at their front faces (as is illustrated by the arrows 13). The single-serve capsule 1 is then enclosed and clamped with form-fit engagement and preferably also force-fit engagement between the two ring segments 8, 9. The connection of the two ring segments 8, 9 at their front faces is effected, for example, via a latch connection or a magnetic connection or a reversible bonded connection.

The single-serve capsule 4 is fastened inside the adapter 1 in particular in such a way that an anti-twist means is formed, by which a rotation of the single-serve capsule 4 relative to the adapter 1 is suppressed.

Alternatively, it would also be conceivable that a further ring 11, as seen from Figure 2b, is arranged above the ring 10.

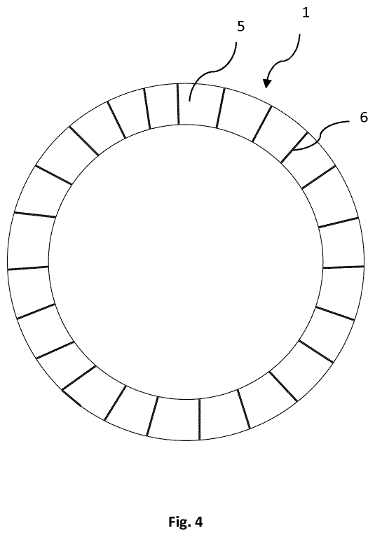

FIG. 4 shows a bottom view of the peripheral flange 5 of the adapter 1 in the first, second and third embodiments of the present invention.

It will be seen that the flange 5 in all three embodiments has a peripheral barcode. Alternatively, it would of course also be conceivable to have a plurality of two-dimensional barcodes applied peripherally on the lowe face of the flange 5.

### LIST OF REFERENCE SIGNS

1 adapter

2 adapter main body

3 receptacle

4 single-serve capsule

5 flange

6 identification means

7 depression

8 first ring segment

9 second ring segment

10 ring

11 further ring

12 fastening direction

13 fastening direction

1. An adapter for use in a single-serve capsule machine, the adapter having an adapter main body with a receptacle, the receptacle being provided to receive a single-serve capsule, wherein the adapter main body is configured as a ring, in a center of which the receptacle for the single-serve capsule is formed, wherein the adapter main body has a peripheral flange, which is provided with an identification means at least in some regions, the identification means being configured as a barcode, which is formed on a lower face of the peripheral flange.

2. The adapter as claimed in claim 1, wherein the identification means is a two-dimensional barcode, which is formed peripherally on the lower face of the peripheral flange.

3. The adapter as claimed in claim 1, wherein the adapter, in a region of the receptacle, comprises a latching means for form-fit and/or force-fit latching onto the single-serve capsule.

4. The adapter as claimed in claim 3, wherein the ring is in two parts, wherein a first ring segment of the ring is reversibly connectable to a second ring segment.

5. The adapter as claimed in claim 4, wherein the adapter is configured in such a way that, by connecting the first ring segment to the second ring segment, the ring is generated and the single-serve capsule is fixed in the receptacle, wherein the single-serve capsule is clamped between the first ring segment and the second ring segment.

6. The adapter as claimed in claim 5, wherein the first ring segment and the second ring segment can be latched onto each other in order to form the ring.

7. The adapter as claimed in claim 1, wherein the ring is in one part.

8. The adapter as claimed in claim 7, wherein the adapter has a further ring, wherein the ring and the further ring are reversibly connectable to each other and are latchable onto each other.

9. The adapter as claimed in claim 8, wherein the adapter is configured in such a way that connecting the ring to the further ring fixes the single-serve capsule in the receptacle, wherein a flange of the single-serve capsule is fastened with form-fit engagement between the ring and the further ring.

10. The adapter as claimed in claim 1, wherein the receptacle comprises a peripheral depression in the adapter main body, in which depression a flange of the single-serve capsule can be received flush therewith.

11. The adapter as claimed in claim 1, wherein the receptacle comprises a peripheral edge in the adapter main body, in which peripheral edge lies a stacking edge formed in an outer contour of the single-serve capsule.

12. The adapter as claimed in claim 1, wherein an outer contour of the adapter is at least partially convex.

13. The adapter as claimed in claim 1, wherein the adapter is designed to hold the single-serve capsule in a rotating brewing chamber of the single-serve capsule machine.

14. The adapter as claimed in claim 13, wherein the adapter has an anti-twist means for receiving the single-serve capsule in a manner fixed in rotation.

15. The adapter as claimed in claim 1, wherein a lengthwise extent of the adapter along its longitudinal axis is shorter than a lengthwise extent of the single-serve capsule along the longitudinal axis.

16. A system consisting of the adapter as claimed in claim 1, and of a single-serve capsule.

17. The system as claimed in claim 16, wherein the system comprises a single-serve capsule machine.

18. The system as claimed in claim 17, wherein the single-serve capsule machine has a brewing chamber for receiving the adapter equipped with the single-serve capsule, and wherein the single-serve capsule machine has at least one perforating means for generating at least one inlet opening in a cover film of the single-serve capsule, through which inlet opening brewing liquid is conveyed into the single-serve capsule, and wherein the single-serve capsule machine has at least one perforating means for generating at least one outlet opening in the cover film, through which opening a beverage generated inside the single-serve capsule, by interaction of the brewing liquid with a beverage substrate, is conveyed out of the single-serve capsule.

19. The system as claimed in claim 18, wherein the brewing chamber can be driven at least partly in rotation during an extraction process, as a result of which a flow of the beverage through the at least one outlet opening is assisted.

20. The adapter as claimed in claim 4, wherein the first ring segment and the second ring segment are each configured in a form of a semicircle.
